(19) United States
(12) Patent Application Publication
(10) Pub. No.: US 2026/0317065 A1
(43) Pub. Date: Oct. 15, 2026

(54) STORAGE SYSTEM FOR STORAGE PURPOSES AND METHOD FOR CORRECTING THE POSITION OF ITEMS

(71) Applicant: TGW Logistics GmbH, Marchtrenk (AT)

(72) Inventors: Thomas HUETTNER, Kirchham (AT); Armin LEITHNER, Steyregg (AT); Lukas WINTER, Gunskirchen (AT)

(73) Assignee: TGW Logistics GmbH, Marchtrenk (AT)

(21) Appl. No.: 19/476,313

(22) PCT Filed: Apr. 19, 2024
(86) PCT No.: PCT/AT2024/060161

§ 371 Date: Oct. 17, 2025

(30) Foreign Application Priority Data
Apr. 20, 2023 (AT) A50294/2023

(51) Int. Cl. B65G 1/137; B65G 1/04

(52) U.S. Cl. CPC B65G 1/1375; B65G 1/0492; B65G 1/1371

(57) ABSTRACT

A storage system for storing a unit load includes an evaluation unit, which is configured for evaluating storage profile data and determining an actual distance between two unit loads arranged next to each other and comparing the actual distance with the target distance and the minimal distance and generating a first instruction or a second instruction for correcting the position of the unit loads depending on whether the actual distance is smaller or greater than the minimal distance. Furthermore, a method corresponds to the storage system.

The invention relates to a storage system for storing a unit load and a method for correcting the position of a unit load in a storage rack of such a storage system. Here, the storage system comprises a rack aisle unit, which has a first storage rack extending in a longitudinal direction, a second storage rack arranged parallel to the first storage rack and a rack aisle arranged between the first and second storage racks, wherein the first and second storage racks respectively comprise multiple rack compartments arranged in rack planes arranged above each other for receiving unit loads, and a transport vehicle, in particular storage and retrieval unit, for storing and/or retrieving unit loads, which has a first detection unit for detecting vacant storage depths in a rack compartment as storage data and a second detection unit for detecting a position of the transport vehicle in a longitudinal direction as position data, wherein the vacant storage depths respectively correspond to a distance in a depth direction of the rack compartment between the first detection unit and a reference element arranged in the rack compartment measured by the first detection unit at a measuring point.

It is problematic in storage systems known from the prior art that vibrations introduced into the storage rack, for example by passing transport vehicles, storage and retrieval units or suchlike, cause the unit loads stored in the storage rack to wander. While the unit loads often wander only by a few centimeters, even this is sufficient for the unit loads to be located too closely together and thus a distance and/or gap between the unit loads to be too small, so that an automated retrieval is no longer possible.

Known from the prior art are different storage systems with storage racks and storage and retrieval units for storing and retrieving a unit load, wherein a correction of the position of the unit load is corrected.

For example, EP 3 418 222 B1 discloses a storage system, wherein the actual position is determined and compared with a target position only for a unit load located closest to the rack aisle. Here, the position of this one unit load is corrected if the actual position deviates from the target position by more than a threshold value, in particular protrudes into the rack aisle and thus obstructs a movement of the transport vehicle.

Also known from EP 2 753 992 B1 is a storage system, wherein an actual position of a unit load inside the storage system is determined by a container mapper. The actual position is compared with a predetermined target position, wherein a correction instruction is generated if the actual position deviates from the target position.

It is disadvantageous here that the respective specific actual position must be determined, so that a high computing power is required on the one hand and large amounts of data are generated on the other hand. Furthermore, a correction is induced here even if the detected unit load does not even have any adjacent unit loads, whereby superfluous corrections are induced in some cases. Furthermore, the actual position can be determined for actually existing unit loads only, so that vacant receiving locations cannot be determined.

It is therefore an object of the invention to specify an improved storage system and method of the kind mentioned in the beginning. In particular, the invention is to enable a reliable and efficient correction of the position of unit loads in the storage system and thus a reliable automated handling of the unit loads.

The object of the invention is achieved by a storage system for storing a unit load and a method for correcting the position of a unit load in a storage rack of such a storage system. Here, the storage system comprises a rack aisle unit, which has a first storage rack extending in a longitudinal direction, a second storage rack arranged parallel to the first storage rack and a rack aisle arranged between the first and second storage racks, wherein the first and second storage racks respectively comprise multiple rack compartments arranged in rack planes arranged above each other for receiving unit loads, and a transport vehicle, in particular storage and retrieval unit, for storing and/or retrieving unit loads, which has a first detection unit, preferably permanently connected to the transport vehicle, for detecting vacant storage depths in a rack compartment as storage data and a second detection unit for detecting a position of the transport vehicle in a longitudinal direction as position data, wherein the vacant storage depths respectively correspond to a distance in a depth direction of the rack compartment between the first detection unit and a reference element arranged in the rack compartment or a defined reference threshold value measured by the first detection unit at a measuring point, and further comprises an evaluation unit, which is configured for receiving and correlating the storage data and position data and generating storage profile data, in particular wherein each vacant storage depth is assigned a position of the transport vehicle, predetermining a target distance and a minimal distance between two unit loads arranged next to each other (in a longitudinal direction), wherein the target distance is greater than the minimal distance, evaluating the storage profile data and determining an actual distance between two unit loads arranged next to each other and comparing the actual distance with the target distance and the minimal distance and generating a first instruction with information for correcting the position of the unit loads arranged next to each other if the actual distance is between the minimal distance and the target distance, or generating a second instruction with other information for correcting the position of the unit loads arranged next to each other if the actual distance is smaller than the minimal distance.

The object is further achieved by a method of the kind mentioned in the beginning, which comprises the following steps:
provisioning the storage system;
moving the transport vehicle in the rack aisle in a longitudinal direction, wherein the transport vehicle passes multiple measuring points;
detecting storage data at the multiple measuring points by the first detection unit and detecting position data by the second detection unit, preferably during the movement of the transport vehicle;
transmitting the detected storage data and position data to the evaluation unit;
predetermining a minimal distance and a target distance between two unit loads, wherein the target distance is greater than the minimal distance;
receiving and correlating the storage data and position data and generating storage profile data by the evaluation unit, in particular wherein each vacant storage depth is assigned a position of the transport vehicle;
evaluating the storage profile data by the evaluation unit, wherein an actual distance between two unit loads arranged next to each other (in a longitudinal direction) is determined;
comparing the actual distance with the target distance and the minimal distance;
generating a first instruction with information for correcting the position of the unit loads arranged next to each other if the actual distance is between the minimal distance and the target distance;
generating a second instruction with other information for correcting the position of the unit loads arranged next to each other if the actual distance is smaller than the minimal distance;
correcting the position of at least one of the unit loads arranged next to each other according to the first or the second instruction.

The object of the invention is additionally achieved by a storage system for storing a unit load comprising a rack aisle unit, which has a first storage rack extending in a longitudinal direction, a second storage rack arranged parallel to the first storage rack and a rack aisle arranged between the first and second storage racks, wherein the first and second storage racks respectively comprise multiple rack compartments arranged in rack planes arranged above each other for receiving unit loads, and a transport vehicle, in particular a storage and retrieval unit, for storing and/or retrieving unit loads, which has a first detection unit for detecting vacant storage depths in a rack compartment as storage data and a second detection unit for detecting a position of the transport vehicle in a longitudinal direction as position data, wherein the vacant storage depths respectively correspond to a distance in a depth direction of the rack compartment between the first detection unit and a reference element arranged in the rack compartment or storage rack or a defined reference threshold value measured by the first detection unit at a measuring point, and further comprises an evaluation unit, wherein the evaluation unit is configured for receiving the storage data and position data, and predetermining a target distance and a minimal distance between two unit loads arranged next to each other, wherein the target distance is greater than the minimal distance, and identifying an actual distance between two unit loads arranged next to each other on the basis of the determined position data and storage data, comparing this actual distance with the target distance and the minimal distance and generating a first instruction with information for correcting the position of the unit loads arranged next to each other if the actual distance is between the minimal distance and the target distance, or generating a second instruction with other information for correcting the position of the unit loads arranged next to each other if the actual distance is smaller than the minimal distance.

The object is further achieved by a method for correcting the position of a unit load in a storage rack comprising the following steps:
provisioning a storage system, in particular a storage system according to the invention;
moving the transport vehicle in the rack aisle in a longitudinal direction, wherein the transport vehicle passes multiple measuring points;
detecting storage data at the multiple measuring points by the first detection unit and detecting position data by the second detection unit, preferably during the movement of the transport vehicle;
transmitting the detected storage data and position data, in particular to an evaluation unit, and receiving the storage data and position data, in particular by the evaluation unit;
predetermining a minimal distance and a target distance between two unit loads, in particular by the evaluation unit, wherein the target distance is greater than the minimal distance;
determining an actual distance between two unit loads arranged next to each other, in particular by the evaluation unit, on the basis of the received position data and storage data;
comparing the actual distance with the target distance and the minimal distance;
generating a first instruction with information for correcting the position of the unit loads arranged next to each other if the actual distance is between the minimal distance and the target distance;
generating a second instruction with other information for correcting the position of the unit loads arranged next to each other if the actual distance is smaller than the minimal distance;
correcting the position of at least one of the unit loads arranged next to each other according to the first or the second instruction.

The unit loads can be arranged next to each other in a longitudinal direction of the storage rack. The transport vehicle may advantageously also be configured for storing and/or retrieving unit loads, for example as a storage and retrieval unit. An advantage achieved with the invention is in particular that the instructions with regard to the correction of the position can be determined on the basis of the distance between merely two unit loads. As a correction of the position is required only if the target distance is fallen below, an additional determination of the actual position of the individual unit loads in the storage rack can be relinquished, whereby a computing time can be shortened on the one hand and amounts of data thereby generated can be reduced on the other hand. The invention thus further ensures that a falling below the target distance is detected in due time and a reliable operation of the storage system is thus enabled. Here, the actual distance corresponds to a gap between the unit loads (in a longitudinal direction of the storage rack).

Another advantage achieved with the invention is in particular that an incorrect position of the unit load can be identified even with relatively short routes of the transport vehicle, for example the method according to the invention can be executed immediately after storing a unit load by moving the transport vehicle only somewhat further, in particular only up to the immediately adjacent storage location, forward and/or backward in a longitudinal direction of the storage rack, and the position of the unit load optionally be corrected in this manner.

The transport vehicle is moved in the rack aisle in a longitudinal direction, so that the transport vehicle passes multiple measuring points; the measurement can be executed during a stop (essentially standstill of the transport vehicle) for the measurement or preferably during the movement of the transport vehicle.

Preferably, the evaluation unit is configured for correlating the storage data and position data and generating storage profile data by assigning a position of the transport vehicle to a, preferably each, vacant storage depth.

To determine the actual distance between two unit loads arranged next to each other, the associated storage data for the determined position data are preferably compared with a reference threshold value.

To determine the actual distance, it is expedient if the actual distance is assigned to a region of the position data in which the storage data exceed the reference threshold value.

It is favorable if the first instruction for a first and/or second unit load of the unit loads arranged next to each other specifies to remove the first and/or second unit load from the rack compartment in an automated manner and to deposit the first and/or second unit load again and newly positioned into the rack compartment, wherein the first and/or second unit load is removed from the rack compartment and is deposited, again and newly positioned, into the rack compartment by the transport vehicle when correcting the position if the first instruction was generated, and/or if the second instruction specifies for a first and/or second unit load of the unit loads arranged next to each other to remove the first and/or second unit load from the rack compartment in a manual manner and to deposit the first and/or second unit load again and newly positioned into the rack compartment in a manual manner, wherein the first and/or second unit load is removed from the rack compartment and is deposited, again and newly positioned, into the rack compartment in a manual manner by a person when correcting the position if the second instruction was generated, wherein the second instruction is displayed at an output unit.

Preferably, a movement of the transport vehicle during the detection of storage data at the multiple measuring points by the first detection unit is executed at a first speed and a movement of the transport vehicle during a detection of position data by the second detection unit is executed at a second speed, which is greater than the first speed. It may also be provided that the transport vehicle drives according to a speed profile alternately at a first and a second speed. The first speed may preferably be smaller than 0.5 m/s. This enables a higher accuracy of the position data and thus position resolution.

It is of particular advantage, however, that the detecting of storage data at the multiple measuring points by the first detection unit and detecting of position data by the second detection unit can be executed in the region of a gap to be expected between the unit loads. The region of a gap to be expected can be expected on the basis of a known width of the unit loads, for example, and is preferably determined on the basis of data from a database.

Preferably, the movement of the transport vehicle can be executed here, in particular without meanwhile detecting storage data, from a first gap to be expected between unit loads to a second gap to be expected between unit loads at a speed that is higher than the speed of the transport vehicle during the detection of storage data at the multiple measuring points by the first detection unit and/or the detection of position data by the second detection unit. This enables a relatively high accuracy of the position data and thus position resolution with an overall swift passage through the rack aisle (in a longitudinal direction).

Preferably, a respective region of a gap to be expected can be determined due to width data of a or the unit loads, for example from data deposited in a database, or is based on a defined grid width of the storage rack or of the receiving locations or rack compartments.

Here, the reference element may be an object, for example a unit load, arranged in the storage rack or in the rack compartment, a disruptive structure arranged in the storage rack, for example an upright of the storage rack, or a rear limitation, in particular a depth stop and/or a push-through protection, of the storage rack or suchlike.

In an advantageous embodiment, a depth stop and/or a push-through protection may even be relinquished, wherein, in particular in such a case, the rear limitation may also be formed by a unit load and/or disruptive contours from adjacent storage locations (of an adjacent storage rack of an adjacent rack aisle unit), which may simply be arranged and detected at a depth exceeding a defined reference threshold value (viewed in a depth direction TG), or merely the defined reference threshold value (i.e. maximal distance value that serves as a reference and/or reference value) is used in such a case, i.e. the vacant storage depth can be set, in particular by the evaluation unit, to the value of a reference depth, for example the maximal storage depth (in a depth direction) of the storage rack and/or (respective) rack compartment or receiving location for a unit load.

The first detection unit can thus be used to determine a distance between the first detection unit and a front edge of the reference element, for example a front face of the unit load, arranged in the region of the measuring point. This distance corresponds to the vacant storage depth, as another unit load may be stored along this distance, for example, if the distance is great enough or the other unit load small enough.

If there is no unit load or other object in the storage rack in the region of the measuring point, a distance to a rear end of the storage rack and/or of the rack compartment in a depth direction is detected here. In this case, the reference element can be formed by a rear limitation and/or depth stop of the storage rack. Here, the depth stop can in particular be provisioned by a (rear) longitudinal beam or a push-through protection, which extends (in a longitudinal direction X) along the storage rack; alternatively, the vacant storage depth can also be set to the (fixed) value of a reference depth in such a case.

It is expedient if the minimal distance between two unit loads is defined such that an automated retrieval is possible if the distance between two unit loads is greater than the minimal distance. The target distance is greater than the minimal distance, whereby a tolerance range between the minimal and the target distance is defined, in which, while an automated handling of the unit load is still possible without any problems, a correction of the position is to be executed in order to be able to reestablish the target distance in an automated manner and avoid a manual correction.

The storage data can be continuously detected by the first detection unit, for example, so that the storage data comprise the vacant storage depths at different time values. Analogously, the position data can be continuously detected by the second detection unit, so that the position data comprise the position at the different time values. The storage data and the position data can be correlated using the time values in this case in order to generate the storage profile data, which comprise the vacant storage depths pertaining to the corresponding positions.

The unit load may be articles, for example, which are stored in the storage rack with or without loading aids. The loading aids may comprise containers or trays, for example, by which the articles are received.

The rack planes extend respectively in a longitudinal direction and depth direction of the storage rack and preferably each form a horizontal plane. Also the rack compartments extend respectively in a longitudinal direction and depth direction and are preferably aligned horizontally.

The rack compartments can be arranged at uprights of the storage rack, for example, and form storage areas arranged between the uprights. Multiple receiving locations for a unit load arranged next to each other and/or in succession can respectively be arranged in the storage areas. If a unit load has been deposited on a receiving location, this is referred to as an occupied receiving location. However, if no unit load is deposited on a receiving location, this is a vacant receiving location. The receiving locations may be predetermined, in particular in a predetermined grid, for example by a warehouse management system. One of many alternative possibilities of arranging receiving locations is described in WO 2022/159999 A1, for example.

The transport vehicle is in particular a storage and retrieval unit, particularly preferably a single-level storage and retrieval unit or multi-level storage and retrieval unit.

Particularly preferably, the transport vehicle is provided and configured for storing and/or retrieving unit loads.

The transport vehicle preferably comprises a base frame, multiple wheels rotatably mounted on the base frame, a travel drive coupled to at least one of the wheels and a control electronics unit for controlling the travel drive.

It is favorable if the first instruction for a first and/or second unit load of the unit loads arranged next to each other specifies to remove the first and/or second unit load of the unit loads arranged next to each other from the rack compartment of the respective storage rack and to deposit the first and/or second unit load of the unit loads arranged next to each other again and newly positioned into the respective storage rack in an automated manner by the transport vehicle, wherein the transport vehicle is configured for receiving and executing the first instruction by the evaluation unit. A correction of the position can thus be executed in an automated manner already when the distance and therefore a gap width is in the tolerance range described above.

The evaluation unit is in particular configured for generating the first and second instructions.

If the transport vehicle is provided and configured as a storage and retrieval unit and/or for storing and/or retrieving unit loads, the receiving of the storage data and position data, and a correlating of these storage and position data to storage profile data may preferably be executed during a drive of the transport vehicle to and/or from a storage location for storing and/or retrieving a unit load. The evaluation unit may advantageously further be configured in particular for generating the first and second instructions at a point in time after a storage and/or retrieval operation of a unit load has been finished.

Advantageously, the first instruction and/or the second instruction for a first and/or second unit load of the unit loads arranged next to each other is executed at a scheduled or next possible point in time. The transport vehicle may advantageously be configured for receiving the first instruction from the evaluation unit and executing the first instruction depending on an operating mode, in particular at the point in time of a specific operating mode, preferably in the idle mode, of the transport vehicle.

If the first instruction was generated, it is thus expedient that the first and/or second unit load is removed from the rack compartment and is deposited, newly positioned, into the rack compartment by the transport vehicle when correcting the position.

Furthermore, it is advantageous if the second instruction specifies for a first and/or second unit load of the unit loads arranged next to each other to remove the first and/or second unit load of the unit loads from the rack compartment, of the respective storage rack, and to deposit the first and/or second unit load of the unit loads again and newly positioned into the rack compartment in a manual manner, wherein the storage system further has a, in particular portable, output unit, which is configured for receiving and displaying the second instruction. The second instruction is preferably generated whenever an automated correction of the position is not possible, for example because a distance between unit loads arranged next to each other is too small for an automated handling.

If the second instruction was generated, it is thus expedient that the first and/or second unit load is removed from the rack compartment and is deposited, newly positioned, into the rack compartment in a manual manner when correcting the position.

Both in case of an automated and in case of a manual correction of the position, it may be provided that the position of only one of the unit loads located next to each other or the positions of both unit loads are corrected. In case of multiple unit loads arranged in succession, the positions of the unit loads arranged in succession and of the unit loads located next to each other can be corrected by jointly removing unit loads arranged in succession from the storage rack and jointly depositing the unit loads again and newly positioned into the storage rack, for example.

The output unit may be a handheld device, for example, with a display unit, on which the second instruction is represented as a description and/or as an explanatory diagram. The removal and depositing of the unit load again into the storage rack may be represented as an (in particular computer-aided and computer-generated) animation, for example.

It is further favorable if the evaluation unit is configured for determining an incorrect position inside the storage rack on the basis of the position data and the output unit is configured for displaying the incorrect position. The incorrect position may be determined, for example, from the position data and the information stating in which rack plane the incorrectness occurred and, in case of multiple rack isle units, optionally in which rack aisle unit the incorrectness occurred. In this way, the person in charge of correcting the position of the unit load can proceed directly to the unit load concerned. In this context, an incorrectness is understood to mean a falling below the target distance, in particular the minimal distance, so that a first or second instruction is generated.

Advantageously, it is provided that the second instruction and/or the incorrect position is displayed on the, in particular portable, output unit described above.

Furthermore, it is favorable if the evaluation unit is configured for evaluating the storage profile data and identifying vacant and/or occupied receiving locations in the storage rack. A vacant receiving location may be provided if a vacant storage depth is determined from the storage profile data based on a width of a unit load and/or of a receiving location in a longitudinal direction; if the vacant storage depth is of the same size as a length of the unit load and/or of the receiving location, or is greater than a length of the unit load and/or of the receiving location, this corresponds to at least one vacant receiving location.

The vacant and/or occupied receiving locations can be identified by the evaluation unit, for example when evaluating the storage profile data.

For example, if the storage rack has a depth in which two receiving locations are arranged in succession and a vacant storage depth is determined in a region across the entire width of a receiving location, which vacant storage depth corresponds to the depth of the storage rack, this means that there are two vacant receiving locations and no occupied receiving location at this location. If a vacant storage depth that corresponds to half the depth of the storage rack, for example, is determined, this means that there is one vacant receiving location and one occupied receiving location at this location. In case of a determined storage depth of less than half the depth, for example, there is no vacant receiving location and two occupied receiving locations.

If vacant and/or occupied receiving locations were determined, it may be advantageous if the evaluation unit is configured for determining a filling degree of the first and/or second storage rack based on the vacant and/or occupied receiving locations. An inventory may thus essentially be realized.

To this end, it is expedient if the method further comprises the following step:
determining a filling degree of the respective storage rack by evaluating the storage profile data by the evaluation unit and determining vacant and/or occupied receiving locations for unit loads in the storage rack.

It is advantageous if the evaluation unit is further configured for determining an orientation of the unit load in the rack compartment based on the storage profile data. This enables a skewing of the unit load to be calculated from a history of the storage profile data in the region of a unit load, for example.

It is thus favorable if a target orientation is further predetermined by the evaluation unit during the predetermining, an orientation of the unit loads is further determined by the evaluation unit during the evaluating of the storage profile data and the determined orientation is compared with the target orientation during the comparing, wherein the method further comprises the following steps:
generating a third instruction with information for correcting the position for a unit load to be corrected if the orientation of this unit load deviates from the target orientation;
correcting the position of the unit load to be corrected according to the third instruction.

To remove a unit load from the storage rack and deposit the unit load into the storage rack, i.e. for the so-called storage and retrieval of the unit load, it may be provided that the transport vehicle has a transport device with a receiving platform for receiving a unit load and two unit load transfer devices located opposite each other and extendable in an extension direction relative to the receiving platform for transferring a unit load between the receiving platform and the rack compartment.

Extending the unit load transfer devices enables the unit load transfer devices to be positioned on opposite sides of a unit load, so that the unit load is received between the unit load transfer devices.

The extension direction extends preferably parallel to the depth direction of the storage rack.

Here, it is preferably provided that the minimal distance between two unit loads corresponds to at least a width of one of the unit load transfer devices. This ensures that the unit load transfer devices can be brought into an intermediate space between the unit loads.

Particularly preferably, the unit load transfer devices are arranged opposite each other at a variable distance. This enables a distance between the unit load transfer devices to be adapted to a width of the unit load to be received.

Furthermore, it may be provided that the transport device has transport elements, which are mounted opposite each other in pairs in a pivoting plane respectively about a pivot axis on respectively one of the unit load transfer devices. The transport elements can be pivoted out of the respective unit load transfer device in order to engage behind a unit load received between the unit load transfer devices and push the unit load out of the rack compartment onto the receiving platform or vice versa in a form-fitting manner during retraction or extension of the unit load transfer devices.

It is favorable if the transport vehicle or the transport vehicles are displaceable in a longitudinal direction along the storage racks, in particular in the rack aisle.

It is expedient if the first detection unit comprises an emitting unit for emitting a measuring beam, in particular in a depth direction, and a receiving unit for receiving a reflected measuring beam.

Here, it is in particular provided that the emitting unit is configured for emitting the measuring beam orthogonally to the longitudinal direction, in particular in a depth direction and/or in an extension direction of the unit load transfer devices. In case of a transport vehicle displaceable along the longitudinal direction, it is thus expedient if the emitting unit is configured for emitting the measuring beam orthogonally to a displacement direction of the transport vehicle, in particular parallel to an axis of rotation of the wheels.

Advantageously, multiple first detection units are provided at the transport vehicle, which multiple first detection units are in particular arranged (preferably so as to be fixed) at the transport vehicle spaced apart from each other in the longitudinal direction. This is in particular advantageous for detecting the vacant (and/or occupied) storage depths in the outermost rack locations (at the ends of the rack aisle).

It is advantageous if the unit load transfer devices each have a telescopic frame and a first telescopic rail extendable relative to the telescopic frame and preferably a second telescopic rail extendable relative to the first telescopic rail, wherein the base frame and the first telescopic rail and/or the first telescopic rail and the second telescopic rail are each movably connected by a guide assembly. Advantageously, the unit load transfer devices comprise the or a respective first detection unit. Advantageously, a respective first detection unit is arranged such here that the respective emitting unit for emitting the measuring beam in an extension direction of the unit load transfer devices is enabled (essentially in alignment with the respective telescopic rail).

Particularly preferably, the or each first detection unit comprises a time-of-flight sensor for detecting the vacant storage depth.

Advantageously, the evaluation unit is configured for identifying a disruptive structure if no reflected measuring beam is received by the receiving unit subsequent to a measuring beam being emitted by the emitting unit. A disruptive structure may be a unit load that is severely skewed, in particular compared to a target orientation, for example.

To detect the position of the transport vehicle, the position of the transport vehicle may be read out directly from a drive control of the transport vehicle by the second detection unit, for example. Alternatively, it may be provided that the second detection unit comprises a rotary encoder coupled to a travel drive and/or to wheels of the transport vehicle. In this way, the position of the transport vehicle can be determined during the method, in particular during the movement of the transport vehicle in the rack aisle in a longitudinal direction, such that the transport vehicle passes multiple measuring points.

It is favorable if the storage system comprises multiple, preferably identically configured, transport vehicles. Here, the transport vehicles may respectively be configured as described above.

It is further advantageous if multiple guide rails are arranged above each other in the rack aisle, respectively in pairs on opposite sides of the rack aisle, wherein the guide rails form a driving plane, respectively in pairs, and the rack planes are each assigned a driving plane. This enables a simpler and improved detecting of vacant storage depths, as no vertical positioning of the first detection unit for detecting vacant storage depths is required, as the first detection unit, which is preferably permanently connected to the transport vehicle, is arranged essentially in fixed (consistent) vertical relation to the transport vehicle while driving on the driving plane and/or in relation to the respective rack plane.

Here, each transport vehicle may be assigned a driving plane in which the transport vehicle drives. Preferably, a transport vehicle is arranged in each driving plane.

To use the advantages and effects described above in the same manner also for the second storage rack of the rack aisle unit, it may be provided that the first detection unit is configured for detecting, in particular simultaneously or alternately, vacant storage depths in a rack compartment of the first storage rack (of the rack aisle unit) and in a rack compartment of the second storage rack (of the rack aisle unit) located opposite the first storage rack (of the rack aisle unit).

In particular, the evaluation unit, detection unit, emitting unit, receiving unit, output unit, display unit, and/or control electronics unit may be configured as microprocessor-based hardware, wherein the functions of these units are implemented as software. Here, also a joint microprocessor-based hardware for multiple functions can be used. Such a unit may likewise be configured on hardware in the form of a so-called field-programmable gate array (FPGA), programmable logic device (PLD) or application-specific integrated circuit (ASIC) or other integrated circuit. Also here, multiple units may be integrated on such a hardware. A unit may likewise be implemented as an analog circuit or analog computer. Further, also any mixes or combinations of these embodiments are possible.

For the purpose of better understanding of the invention, it will be elucidated in more detail by means of the figures below.

These show in a very simplified schematic representation:

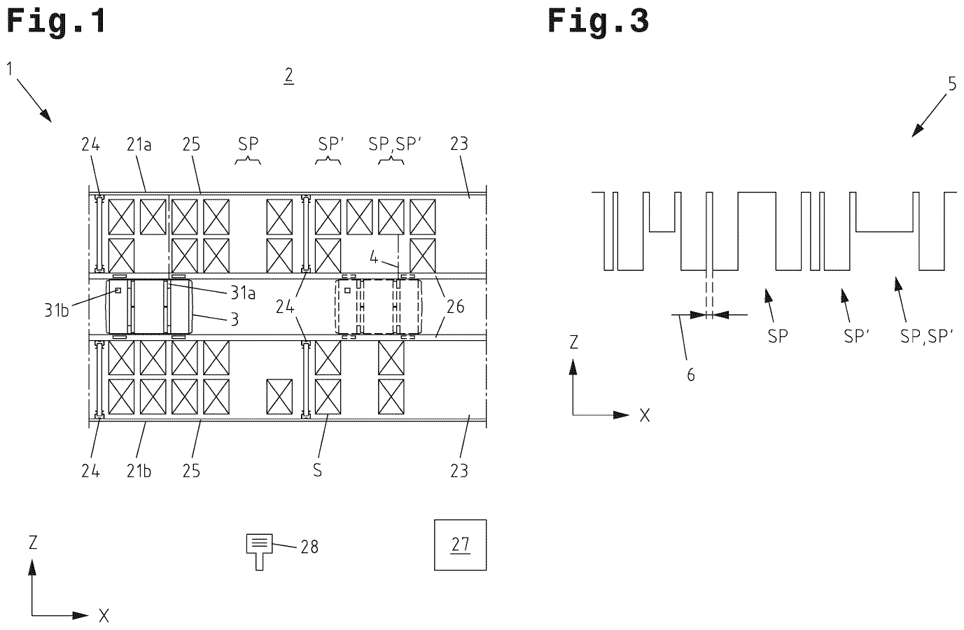

FIG. 1 a rack aisle unit in a top view;

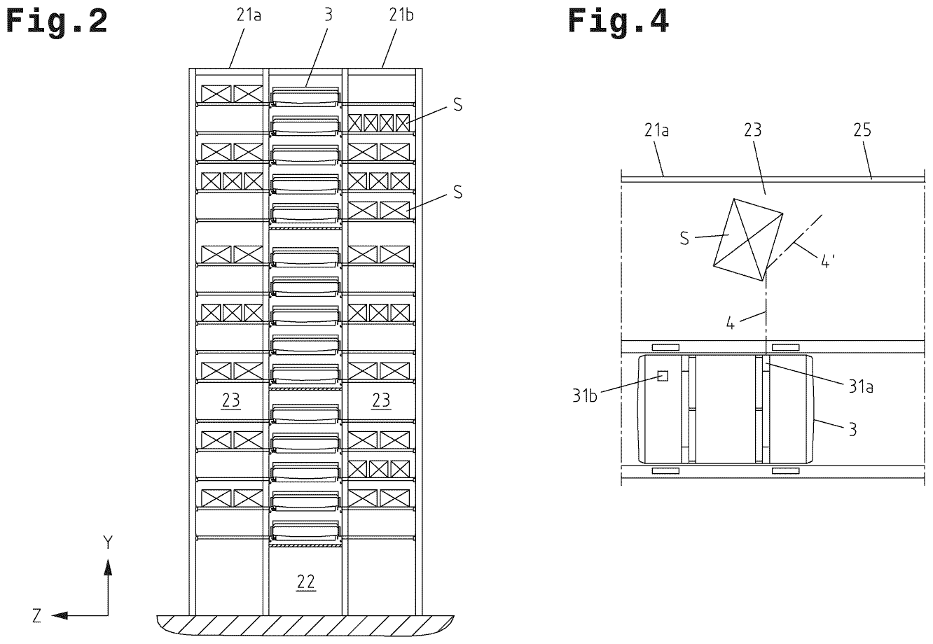

FIG. 2 the rack aisle unit in a front view;

FIG. 3 storage profile data;

FIG. 4 a detail of the rack aisle unit in a top view;

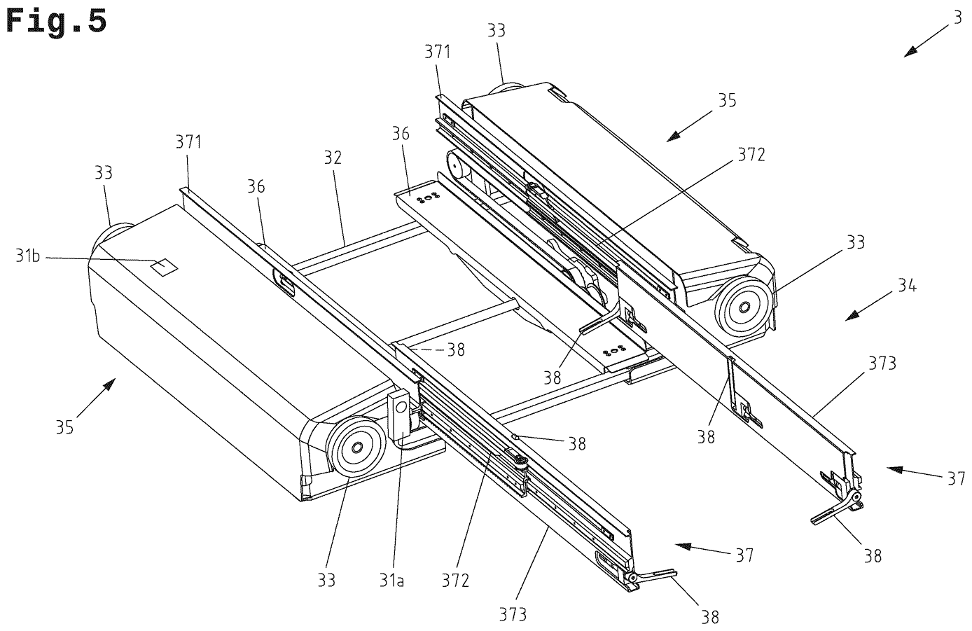

FIG. 5 a transport vehicle;

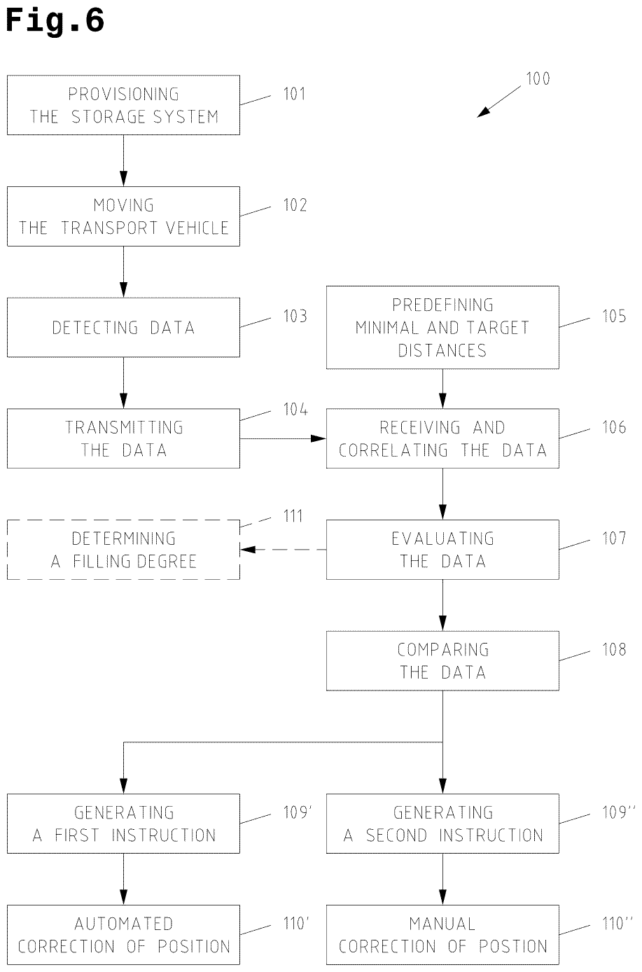

FIG. 6 a method for correcting the position of unit loads;

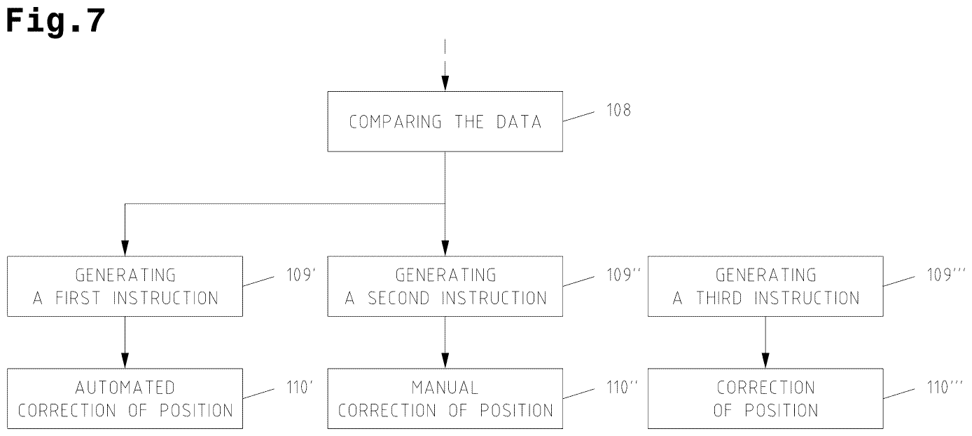

FIG. 7 optional other steps of the method.

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, are to be analogously transferred to the new position.

FIG. 1 shows a detail of a storage system 1 for storing a unit load S. As can be seen, the storage system 1 comprises at least one rack aisle unit 2 and at least one transport vehicle 3, which is represented in FIG. 1 by a solid line in a first position and by a dashed line in a second position.

In addition to the rack aisle unit 2 shown in FIG. 1, the storage system 1 can have a plurality of rack isle units 2.

The rack aisle unit 2 comprises a first storage rack 21a and a second storage rack 21b, which are arranged parallel to each other and extend in a longitudinal direction X. Between the storage racks 21a, 21b, there is a rack aisle 22, in which transport vehicles 3 are displaceable along the storage racks 21a, 21b.

The storage racks 21a, 21b comprise rack compartments 23, which form storage areas, which are arranged between uprights 24. In the rack compartments 23, multiple receiving locations SP, SP′ arranged next to each other and/or in succession are provided, on which unit loads S can be deposited, as can be seen in FIG. 1.

The rack compartments 23 extend along the depth direction Z respectively from a front side facing the rack aisle 22 to a rear side facing away from the rack aisle 22. At the rear side of the rack compartments 23, a limitation element, for example a longitudinal beam 25, may be provided, which limits the rack compartment 23 at the rear side facing away from the rack aisle 22.

It may further be provided that respectively one guide rail 26 extends along the front side of the rack compartments 23, which guide rails 26 are arranged opposite each other in pairs. Here, one guide rail 26 of a guide rail pair is mounted on the first storage rack 21a and the other guide rail 26 of the guide rail pair is mounted on the second storage rack 21b. On the guide rails 26, the transport vehicle 3 may be arranged to as to be displaceable.

FIG. 2 shows the rack aisle unit 2 in a front view, wherein the first storage rack 21a is represented on the left hand side and the second storage rack 21b is represented on the right hand side. As can be seen here, the storage racks 21a, 21b may comprise multiple rack compartments 23, which are arranged in rack planes located above each other, in particular in a height direction Y.

It may further be provided that each rack plane is assigned a guide rail pair, which forms a driving plane, in which a transport vehicle 3 is displaceable. In this way, as shown in FIG. 2, a transport vehicle 3, which is assigned to the respective rack plane, may be arranged in each driving plane. The storage system 1 may therefore comprise multiple transport vehicles 3.

The transport vehicle 3 is configured for retrieving unit loads S from one of the storage racks 21a, 21b, in particular from the rack compartment 23, and/or storing units loads S in one of the storage racks 21a, 21b, in particular in the rack compartment 23, on the one hand. On the other hand, the transport vehicle 3 is configured for detecting a vacant storage depth in the rack compartment 23 by a first detection unit 31a, preferably permanently connected to the transport vehicle 3, and the individual position of the transport vehicle 3 along the storage racks 21a, 21b by a second detection unit 31b.

To detect the vacant storage depth, the first detection unit 31a may be configured for emitting a measuring beam 4 and receiving a reflected measuring beam 4′, for example. To this end, the first detection unit 31a may have an emitting unit and/or a receiving unit, for example.

The detected storage depths and the individual position of the transport vehicle 3 may be transmitted to an evaluation unit 27 of the storage system 1 by the transport vehicle 3. The evaluation unit 27 may be a central evaluation unit 27 of the storage system 1 as represented, for example a computer, or an evaluation unit 27 arranged at the respective transport vehicle 3.

The evaluation unit 27 can be used to receive the storage data and position data, and an actual distance 6 between two unit loads S arranged next to each other can be identified on the basis of the determined position data and storage data.

The evaluation unit 27 can be used also to correlate the storage depths and the position of the transport vehicle 3 in order to thus generate storage profile data 5 represented in FIG. 3 for the first storage rack 21a by way of example.

The storage profile data 5 comprise the storage depths in a depth direction Z measured at the different measuring points and the position of the individual measuring points in a longitudinal direction X of the storage racks 21a, 21b, on the one hand. A distance between two unit loads S arranged next to each other can be determined from the storage profile data 5, as represented in FIG. 3.

The evaluation unit 27 can identify the actual distance 6 between two unit loads S arranged next to each other by comparing the associated storage data for the determined position data with a reference threshold value. Further, the actual distance 6 can be assigned to a region of the position data in which the storage data exceed the reference threshold value.

Vacant receiving locations SP and/or occupied receiving locations SP′ can further be determined from the storage profile data 5 and in particular a filling degree of the first or second storage rack 21a, 21b can be determined from the number of vacant receiving locations SP and/or occupied receiving locations SP′.

Based on the distance, the evaluation unit 27 can generate and optionally transmit to the transport vehicle 3 and/or to an a output unit 28 a first or second instruction with information for correcting the position of the unit loads S arranged next to each other. The output unit 28 may be configured as a handheld device, for example, as schematically represented (disproportionately large) in FIG. 1.

If a disruptive structure, for example a unit load S whose orientation deviates from a target orientation as shown in FIG. 4, is arranged in one of the storage racks 21a, 21b, it may happen that the reflected measuring beam 4′ is not reflected back to the transport vehicle 3 and thus also not to the first detection unit 31a, in particular not to the receiving unit. In this case, while the first detection unit 31a would emit a measuring beam 4, it would not receive a signal, so that the storage profile data 5 essentially comprise a gap at the corresponding position. This case can be identified as a disruptive structure in the respective storage rack 21a, 21b by the evaluation unit 27. It is favorable here if a third instruction with information for a correction of the position for a unit load S to be corrected is generated, in particular by the evaluation unit 27.

FIG. 5 shows a perspective view of an embodiment of a transport vehicle 3, which is configured as a single-level storage and retrieval unit.

The transport vehicle 3 preferably has a base frame 32, multiple wheels 33 rotatably mounted on the base frame 32, a travel drive that cannot be seen in FIG. 5 for driving at least one wheel 33, a transport device 34 for receiving a unit load S and/or a control electronics unit, which is not represented, for controlling the travel drive. Furthermore, the transport vehicle 3 may comprise a housing 35, wherein the travel drive and the control electronics unit are arranged or can be arranged inside the housing 35.

To receive a unit load S, the transport device 34 may comprise a receiving platform 36, in particular defining a receiving plane. As shown in FIG. 5, the receiving platform 36 can be formed by multiple, in particular two, unit load rests, for example.

To transfer the unit load S between one of the storage racks 21a, 21b, in particular the rack compartment 23, and the receiving platform 36, the transport device 34 may comprise one or multiple unit load transfer devices 37, in particular mounted extendably and parallel to each other on the base frame 32.

The unit load transfer devices 37 preferably each have a telescopic frame 371 and telescopic rails horizontally extendable relative to the telescopic frame 371. A first telescopic rail 372 is mounted on the telescopic frame 371 so as to be displaceable using a guide assembly. Furthermore, the second telescopic rail 373 is mounted on the first slide so as to be displaceable using a guide assembly. The first slide can be moved relative to the telescopic frame 371 with the help of a drive device (not represented). In the example shown, the unit load transfer devices 37 are thus respectively configured essentially as a telescopic unit and/or telescopic arm.

To transport a unit load S, the transport devices 34 may respectively comprise at least one transport element 38, which is arranged in particular at the second telescopic rail 373. Preferably, each transport element 38 is coupled to an electric drive motor and movable between an initial position and an actuation position using the electric drive motor. In the example shown, outer transport elements 38 arranged in end regions of the second slide are arranged in the actuation position and inner transport elements 38 arranged between the outer transport elements 38 are arranged in the initial position.

FIG. 6 shows a method 100 for correcting the position of a unit load S in such a storage system 1. Here, the storage system 1 is first provisioned 101, as described above, along with transport vehicle(s) 3 with unit loads S located in the transport vehicle(s) 3. During operation of the storage system 1, the transport vehicle 3 is moved 102, wherein the transport vehicle 3 drives along the storage racks 21a, 21b.

During the moving 102, there may be a detecting 103 of the storage data and position data described above at multiple measuring points along the respective storage rack 21a, 21b by the respective detection units 31a, 31b, in particular without stopping the movement of the transport vehicle 3. The detected storage data and position data can then be transmitted 104 to the evaluation unit 27 by the respective detection unit 31a, 31b.

The detection 103 of the storage data and position data at the respective measuring points along the respective storage rack 21a, 21b by the respective detection units 31a, 31b can be executed while the transport vehicle 3 is moving or while the transport vehicle 3 is standing still.

There may also be both a detection 103 of storage data and position data at measuring points while the transport vehicle 3 is moving and a detection 103 of storage data and position data at measuring points while the transport vehicle 3 is standing still. This means that the detection 103 of a part of the storage data and position data is executed at measuring points while the transport vehicle 3 is moving and the detection 103 of a part of storage data and position data is executed at measuring points while the transport vehicle 3 is standing still.

The evaluation unit 27 may predetermine 105 a minimal distance and of a target distance. This can be executed at any point in time of the method 100 before an evaluating 107 of data described below, for example already when provisioning 101 the storage system 1. Here, the minimal distance is in particular predetermined such that it corresponds to at least a width of one of the unit load transfer devices 37, so that the unit load transfer devices 37 can be brought into an intermediate space between the unit loads S if the distance is greater than the minimal distance. A distance with which an automated storage and/or retrieval of the unit loads S can be executed reliably is defined as a target distance.

The transmitted storage and position data can be received and correlated 106 by the evaluation unit 27 in a next step, wherein the storage profile shown in FIG. 3 and/or the storage profile data 5 shown are generated, for example.

The storage profile data 5 can be evaluated 107 by the evaluation unit 27 in order to determine an actual distance 6 between unit loads S arranged next to each other. The actual distance 6 determined in this process can now be compared 108 with the target and minimal distances.

If the actual distance 6 is greater than or equal to the target distance, no further action is required. A reliable operation of the storage system 1 is ensured.

If the actual distance 6 is smaller than the target distance but greater than the minimal distance, a first instruction is generated 109′. The first instruction contains information for correcting the position of the unit loads S arranged next to each other. This information may state, for example, that one of the or the unit loads S arranged next to each other are to be retrieved (from the rack compartment and/or from the respective receiving location SP) and stored, newly positioned, back into the rack compartment and/or the respective receiving location SP by the transport vehicle 3. This may in particular be executed for the unit load S or the unit loads S on one side of the gap between the unit loads S and for the unit load S or the unit loads S on the other side of the gap between the unit loads S.

If the actual distance 6 is smaller than the minimal distance, a second instruction 109″ is generated. The second instruction contains other information for correcting the position of the unit loads S arranged next to each other. This information may state, for example, that one of the or the unit loads S arranged next to each other are to be retrieved (from the rack compartment and/or from the respective receiving location SP) and stored, newly positioned, back into the rack compartment and/or the respective receiving location SP in a manual manner by a person. This may in particular be executed for the unit load S or the unit loads S on one side of the gap between the unit loads S and for the unit load S or the unit loads S on the other side of the gap between the unit loads S.

Finally, a manual or automated correcting 110′, 110″ of the position of the unit load S or the unit loads S is executed according to the respective instruction, electively by a person or by the transport vehicle 3, depending on whether the first or second instruction was generated. If no instruction was generated, a correcting is not required.

Furthermore, it may be provided that a filling degree is determined 111 by the evaluation unit 27 on the basis of the storage profile data 5 by identifying vacant receiving locations SP and/or occupied receiving locations SP′.

It may optionally be provided that a target orientation for each of the unit loads S is predetermined in addition when predetermining 105 the minimal and target distances. An orientation may optionally be determined here when evaluating 107 the storage profile data 5 and the orientation may subsequently be compared with the target orientation when comparing 108 the data.

As represented in FIG. 7, it may optionally be provided that a third instruction 109′″ is generated if the orientation deviates from the target orientation. Analogously to the first and second instructions, the third instruction contains information for correcting the position of the unit load S. This information may state, for example, that the unit load S is to be retrieved from and stored, newly positioned, back into the rack compartment in a manual manner by a person or in an automated manner by the transport vehicle 3. This can be executed during a subsequent correcting 110″ according to the third instruction.

Finally, it should also be noted that the scope of protection is determined by the claims.

However, the description and the drawings are to be adduced for construing the claims. Individual features or feature combinations from the different exemplary embodiments shown and described may represent independent inventive solutions.

In particular, it should also be noted the devices depicted may, in reality, also comprise more, or also fewer, components than depicted. In some cases, the shown devices and/or their components may not be depicted to scale and/or be enlarged and/or reduced in size.

Table of reference numbers

| | | | |
|---|---|---|---|
| 1 | storage system | 100 | method |
| 2 | rack aisle unit | 101 | provisioning the |
| 21a, 21b | storage rack | | storage system |
| 22 | rack aisle | 102 | moving the transport |
| 23 | rack compartment | | vehicle |
| 24 | upright | 103 | detecting data |
| 25 | longitudinal beam | 104 | transmitting the data |
| 26 | guide rail | 105 | predetermining |
| 27 | evaluation unit | | minimal and target |
| 28 | output unit | | distances |
| 3 | transport vehicle | 106 | receiving and |
| 31a, 31b | detection unit | | correlating data |
| 32 | base frame | 107 | evaluating data |
| 33 | wheel | 108 | comparing distances |
| 34 | transport device | 109′ . . . 109″′ | generating instructions |
| 35 | housing | 110′ . . . 110″′ | correcting a position |
| 36 | receiving platform | 111 | determining a filling |
| 37 | unit load transfer | | degree |
| | device | | |
| 371 | telescopic frame | | |
| 372, 373 | telescopic rail | | |
| 38 | transport element | | |
| 4, 4′ | measuring beam | | |
| 5 | storage profile data | | |
| 6 | actual distance | | |
| S | unit load | | |
| SP, SP′ | receiving location | | |
| X | longitudinal | | |
| | direction | | |
| Y | height direction | | |
| Z | depth direction | | |

1. A storage system (1) for storing a unit load(S) comprising
a rack aisle unit (2), which has a first storage rack (21a) extending in a longitudinal direction (X), a second storage rack (21b) arranged parallel to the first storage rack (21a) and a rack aisle arranged between the first and second storage racks (22),
wherein the first and second storage racks (21b) respectively comprise multiple rack compartments (23) arranged in rack planes arranged above each other for receiving unit loads(S), and
a transport vehicle (3), in particular a storage and retrieval unit for storing and/or retrieving unit loads(S), which has a first detection unit (31a) for detecting vacant storage depths in a rack compartment (23) as storage data and a second detection unit (31b) for detecting a position of the transport vehicle (3) in a longitudinal direction (X) as position data, wherein the vacant storage depths respectively correspond to a distance, measured by the first detection unit (31a) at a measuring point, in a depth direction (Z) of the rack compartment (23) between the first detection unit (31a) and a reference element arranged in the rack compartment (23),
wherein
the storage system (1) further comprises an evaluation unit (27), configured for receiving and correlating the storage data and position data and generating storage profile data (5),
predetermining a target distance and a minimal distance between two unit loads(S) arranged next to each other, wherein the target distance is greater than the minimal distance,
evaluating the storage profile data (5) and determining an actual distance (6) between two unit loads(S) arranged next to each other and comparing the actual distance (6) with the target distance and the minimal distance, and
generating a first instruction with information for correcting the position of the unit loads(S) arranged next to each other if the actual distance (6) is between the minimal distance and the target distance, or generating a second instruction with other information for correcting the position of the unit loads(S) arranged next to each other if the actual distance (6) is smaller than the minimal distance.

2. The storage system (1) according to claim 1, wherein the first instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads(S) again and newly positioned into the rack compartment (23) in an automated manner by the transport vehicle (3), wherein the transport vehicle (3) is configured for receiving the first instruction from the evaluation unit (27) and executing the first instruction.

3. The storage system (1) according to claim 1, wherein the second instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads (S) again and newly positioned into the rack compartment (23) in a manual manner, wherein the storage system (1) further has a, in particular portable, output unit (28), configured for receiving and displaying the second instruction.

4. The storage system (1) according to claim 3, wherein the evaluation unit (27) is configured for determining an incorrect position inside the storage rack on the basis of the position data and the output unit (28) is configured for displaying the incorrect position.

5. The storage system (1) according to claim 1, wherein the evaluation unit (27) is configured for evaluating the storage profile data (5) and identifying vacant receiving locations (SP) and/or occupied receiving locations (SP′) in the storage rack.

6. The storage system (1) according to claim 5, wherein the evaluation unit (27) is configured for determining a filling degree of the first and/or second storage rack (21a, 21b) based on the vacant receiving locations (SP) and/or occupied receiving locations (SP′).

7. The storage system (1) according to claim 1, wherein the evaluation unit (27) is configured for determining an orientation of the unit load(S) in the rack compartment (23) based on the storage profile data (5).

8. The storage system (1) according to claim 1, wherein the transport vehicle (3) has a transport device (34) with a receiving platform (36) for receiving a unit load(S) and two unit load transfer devices (37) located opposite each other and extendable relative to the receiving platform (36) in an extension direction for transferring a unit load(S) between the receiving platform (36) and the rack compartment (23), wherein the minimal distance between two unit loads(S) corresponds to at least a width of one of the unit load transfer devices (37).

9. The storage system (1) according to claim 1, wherein the first detection unit (31a) comprises an emitting unit for emitting a measuring beam (4), in particular in a depth direction (Z), and a receiving unit for receiving a reflected measuring beam (4′).

10. The storage system (1) according to claim 9, wherein the emitting unit is configured for emitting the measuring beam (4) orthogonally to the longitudinal direction (X), in particular in a depth direction (Z).

11. The storage system (1) according to claim 9, wherein the evaluation unit (27) is configured for identifying a disruptive structure if no reflected measuring beam (4′) is received by the receiving unit subsequent to a measuring beam (4) being emitted by the emitting unit.

12. The storage system (1) according to claim 1, wherein the second detection unit (31b) comprises a rotary encoder coupled to a travel drive and/or to wheels (33) of the transport vehicle (3).

13. The storage system (1) according to claim 1, wherein the storage system (1) comprises multiple, preferably identically configured, transport vehicles (3).

14. The storage system (1) according to claim 1, wherein multiple guide rails (26) are arranged above each other in the rack aisle (22), respectively in pairs on opposite sides of the rack aisle (22), wherein the guide rails (26) form a driving plane, respectively in pairs, and the rack planes are each assigned a driving plane.

15. The storage system (1) according to claim 1, wherein the first detection unit (31a) is configured for detecting, in particular simultaneously or alternately, vacant storage depths in a rack compartment (23) of the first storage rack (21a) and in a rack compartment (23) of the second storage rack (21b) located opposite the rack compartment (23) of the first storage rack (21a).

16. A method (100) for correcting the position of a unit load(S) in a storage rack (21a, 21b) comprising the following steps:
provisioning (101) the storage system (1) according to claim 1;
moving (102) the transport vehicle (3) in the rack aisle (22) in a longitudinal direction (X), wherein the transport vehicle (3) passes multiple measuring points;
detecting (103) storage data at the multiple measuring points by the first detection unit (31a) and detecting position data by the second detection unit (31b), preferably during the movement of the transport vehicle (3);
transmitting (104) the detected storage data and position data to the evaluation unit (27);
predetermining (105) a minimal distance and a target distance between two unit loads(S), wherein the target distance is greater than the minimal distance;
receiving and correlating (106) the storage data and position data and generating storage profile data (5) by the evaluation unit (27);
evaluating (107) the storage profile data (5) by the evaluation unit (27), wherein an actual distance (6) between two unit loads(S) arranged next to each other is determined;
comparing (108) the actual distance (6) with the target distance and the minimal distance;
generating (109′) a first instruction with information for correcting the position of the unit loads(S) arranged next to each other if the actual distance (6) is between the minimal distance and the target distance;
generating (109″) a second instruction with other information for correcting the position of the unit loads(S) arranged next to each other if the actual distance (6) is smaller than the minimal distance;
correcting (110′, 110″) the position of at least one of the unit loads(S) arranged next to each other according to the first or the second instruction.

17. The method (100) according to claim 16, wherein the first instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads(S) again and newly positioned into the rack compartment (23) in an automated manner, wherein the first and/or second unit load(S) of the unit loads(S) is removed from the rack compartment (23) and is deposited, again and newly positioned, into the rack compartment by the transport vehicle (3) when correcting the position if the first instruction was generated.

18. The method (100) according to claim 16, wherein the second instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads(S) again and newly positioned into the rack compartment (23) in a manual manner, wherein the first and/or second unit load(S) is removed from the rack compartment (23) and is deposited, newly positioned, into the rack compartment (23) in a manual manner by a person when correcting the position if the second instruction was generated.

19. The method (100) according to claim 16, further comprising the step:
determining (111) a filling degree of the first and/or second storage rack (21a, 21b) by the storage profile data (5) being evaluated by the evaluation unit (27) and vacant and/or occupied receiving locations (SP′) for unit loads(S) being determined in the respective storage rack (21a, 21b).

20. The method (100) according to claim 16, wherein a target orientation is further predetermined by the evaluation unit (27) during the predetermining (105), an orientation of the unit loads(S) is further determined by the evaluation unit (27) during the evaluating (107) of the storage profile data (5) and the determined orientation is compared with the target orientation during the comparing (108), wherein the method (100) further comprises the following steps:
generating (109″) a third instruction with information for correcting the position for a unit load(S) to be corrected if the orientation of this unit load(S) deviates from the target orientation;
correcting (110″) the position of the unit load(S) to be corrected according to the third instruction.

21. The method (100) according to claim 16, wherein the detecting of storage data at the multiple measuring points and detecting of position data are executed in the region of a gap to be expected between the unit loads(S).

22. The method (100) according to claim 21, wherein a movement of the transport vehicle (3) from a first gap to be expected between unit loads to a second gap to be expected between unit loads is executed at a speed that is higher than the speed of the transport vehicle during the detection of storage data in the region of the first and/or second gap to be expected between unit loads.

23. The method (100) according to claim 22, wherein the speed of the movement of the transport vehicle (3) from a first gap to be expected between unit loads to the second gap to be expected between unit loads is higher than the speed of the transport vehicle during the detection of storage data in the region of the first and/or second gap to be expected.

24. The method (100) according to claim 21, wherein no storage data are detected during the movement of the transport vehicle (3) from a first gap to be expected between unit loads to the second gap to be expected between unit loads.

25. The method (100) according to claim 16, wherein a movement of the transport vehicle (3) during the detection of storage data at the multiple measuring points is executed at a first speed, and wherein a movement of the transport vehicle during a detection of position data is executed at a second speed, which is greater than the first speed.

26. A storage system (1) for storing a unit load(S) comprising
a rack aisle unit (2), which has a first storage rack (21a) extending in a longitudinal direction (X), a second storage rack (21b) arranged parallel to the first storage rack (21a) and a rack aisle (22) arranged between the first and second storage racks (21a, 21b), wherein the first and second storage racks (21a, 21b) respectively comprise multiple rack compartments (23) arranged in rack planes arranged above each other for receiving unit loads(S), and
a transport vehicle (3), in particular a storage and retrieval unit, for storing and/or retrieving unit loads(S), which has a first detection unit (31a) for detecting vacant storage depths in a rack compartment (23) as storage data and a second detection unit (31b) for detecting a position of the transport vehicle (3) in a longitudinal direction (X) as position data, wherein the vacant storage depths respectively correspond to a distance, measured by the first detection unit (31a) at a measuring point, in a depth direction (Z) of the rack compartment (23) between the first detection unit (31a) and a reference element arranged in the rack compartment (23) or a defined reference threshold value, wherein
the storage system (1) further comprises an evaluation unit (27), configured for receiving the storage data and position data, and
predetermining a target distance and a minimal distance between two unit loads(S) arranged next to each other, wherein the target distance is greater than the minimal distance, and
identifying an actual distance (6) between two unit loads(S) arranged next to each other on the basis of the determined position data and storage data,
comparing the actual distance (6) with the target distance and the minimal distance and generating a first instruction with information for correcting the position of the unit loads(S) arranged next to each other if the actual distance (6) is between the minimal distance and the target distance, or
generating a second instruction with other information for correcting the position of the unit loads(S) arranged next to each other if the actual distance (6) is smaller than the minimal distance.

27. The storage system (1) according to claim 26, wherein
the evaluation unit (27) is configured for identifying the actual distance (6) between two unit loads(S) arranged next to each other by comparing the associated storage data for the determined position data with a reference threshold value.

28. The storage system (1) according to claim 26, wherein
the evaluation unit (27) is additionally configured for identifying the actual distance (6) between two unit loads(S) arranged next to each other by assigning the actual distance (6) to a region of the position data in which the storage data exceed the reference threshold value.

29. A method (100) for correcting the position of a unit load(S) in a storage rack (21a, 21b) comprising the following steps:
provisioning (101) the storage system (1) according to claim 21;
moving (102) the transport vehicle (3) in the rack aisle (22) in a longitudinal direction (X), wherein the transport vehicle (3) passes multiple measuring points;
detecting (103) storage data at the multiple measuring points by the first detection unit (31a) and detecting position data by the second detection unit (31b), preferably during the movement of the transport vehicle (3);
transmitting (104) the detected storage data and position data to the evaluation unit (27) and receiving the storage data and position data by the evaluation unit (27);
predetermining (105) a minimal distance and a target distance between two unit loads(S) by the evaluation unit (27), wherein the target distance is greater than the minimal distance;
determining an actual distance (6) between two unit loads(S) arranged next to each other by the evaluation unit (27) on the basis of the received position data and storage data;
comparing (108) the actual distance (6) with the target distance and the minimal distance;
generating (109′) a first instruction with information for correcting the position of the unit loads(S) arranged next to each other if the actual distance (6) is between the minimal distance and the target distance;
generating (109″) a second instruction with other information for correcting the position of the unit loads(S) arranged next to each other if the actual distance (6) is smaller than the minimal distance;
correcting (110′, 110″) the position of at least one of the unit loads(S) arranged next to each other according to the first or the second instruction.

30. The method (100) according to claim 29, wherein, to determine the actual distance (6) between two unit loads(S) arranged next to each other, the associated storage data for the determined position data are compared with a reference threshold value.

31. The method (100) according to claim 30, wherein, to determine the actual distance (6), the actual distance (6) is assigned to a region of the position data in which the storage data exceed the reference threshold value.

32. The method (100) according to claim 29, wherein the first instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads(S) again and newly positioned into the rack compartment (23) in an automated manner, wherein the first and/or second unit load(S) is removed from the rack compartment (23) and is deposited, again and newly positioned, into the rack compartment (23) by the transport vehicle (3) when correcting the position if the first instruction was generated, and/or wherein the second instruction specifies for a first and/or second unit load(S) of the unit loads(S) arranged next to each other to remove the first and/or second unit load(S) of the unit loads(S) arranged next to each other from the rack compartment (23) and to deposit the first and/or second unit load(S) of the unit loads(S) again and newly positioned into the rack compartment (23) in a manual manner, wherein the first and/or second unit load(S) is removed from the rack compartment (23) and is deposited, again and newly positioned, into the rack compartment (23) in a manual manner by a person when correcting the position if the second instruction was generated, wherein the second instruction is displayed at an output unit (28).

33. The method (100) according to claim 29, wherein the detecting of storage data at the multiple measuring points and detecting of position data are executed in the region of a gap to be expected between the unit loads.

34. The method (100) according to claim 33, wherein a movement of the transport vehicle (3) from a first gap to be expected between unit loads to a second gap to be expected between unit loads is executed at a speed that is higher than the speed of the transport vehicle during the detection of storage data in the region of the first and/or second gap to be expected between unit loads.

35. The method (100) according to claim 33, wherein the speed of the movement of the transport vehicle (3) from a first gap to be expected between unit loads to the second gap to be expected between unit loads is higher than the speed of the transport vehicle during the detection of storage data in the region of the first and/or second gap to be expected.

36. The method (100) according to claim 33, wherein no storage data are detected during the movement of the transport vehicle (3) from a first gap to be expected between unit loads to the second gap to be expected between unit loads.

37. The method (100) according to claim 29, wherein a movement of the transport vehicle (3) during the detection of storage data at the multiple measuring points is executed at a first speed, and wherein a movement of the transport vehicle (3) during a detection of position data is executed at a second speed, which is greater than the first speed.
